(19) United States
(12) Patent Application Publication
(10) Pub. No.: US 2002/0049668 A1
(43) Pub. Date: Apr. 25, 2002

(54) Electronic business transaction assisting system and method

(75) Inventors: Kota Nezu, Toyota-shi (JP); Simon David Humphries, Aichi-gun (JP); Kikuko Yamawa, Toyota-shi (JP); Norihiro Matsubara, Okazaki-shi (JP)

Correspondence Address: OLIFF & BERRIDGE, PLC, P.O. BOX 19928, ALEXANDRIA, VA, 22320, US

(73) Assignee: TOYOTA JIDOSHA KABUSHIKI KAISHA, TOYOTA-SHI (JP)

(21) Appl. No.: 09/977,953

(22) Filed: Oct. 17, 2001

(30) Foreign Application Priority Data
Oct. 19, 2000 (JP) 2000-319580

(51) Int. Cl. G06F 17/60

(52) U.S. Cl. 705/37

(57) ABSTRACT

A server that includes a memory that stores data indicative of an actual delivery time of each of a plurality of commodities and a controller that receives data indicative of a desired delivery time and selects at least one of the plurality of commodities that meets the desired delivery time on the basis of the actual delivery times of the plurality of the commodities stored in the memory and the received desired delivery time, and provides a result of the at least one selection made. The server enable consumers to easily learn delivery times of commodities in order to make more informed decisions.

### INCORPORATION BY REFERENCE

The disclosure of Japanese Patent Application No. 2000-319580 filed on October 19, 2000 including the specification, drawings and abstract is incorporated herein by reference in its entirety.

### BACKGROUND OF THE INVENTION

1. Field of Invention

The present invention relates in general to electronic business transaction assisting system, a server constituting a portion of the system, method for assisting an electronic business transaction, a computer program for a electronic business transaction assisting system, and a recording medium for a electronic business transaction assisting system.

2. Description of Related Art

Electronic business transactions are becoming more and more popular, keeping pace with developments in Internet communications. For example, an electronic business transaction assisting system can function to enable a user terminal to display a catalog of commodities or goods for business transaction, utilizing a web page of the Internet and enable a supplier to receive a purchase order a commodity transmitted from a user terminal through the Internet. Furthermore, of an electronic business transaction assisting system can function to enable the user terminal to make an inquiry of delivery times of individual commodities, as disclosed in JP-A-5-274326.

However, the electronic business transaction assisting systems described above do not address the following problems. In many instances, not only the features of the commodities, but also the delivery times of the commodities, are usually important to a consumer who is thinking of purchasing a commodity. For example, a person may be thinking of purchasing a TV set to watch the Olympic Games scheduled to begin one week later. The person desires to purchase a TV set from a supplier A. However, the delivery time of the TV set from supplier A is one month. In this case, the person would want to purchase a TV set available from any other supplier that could deliver the TV set in one week or less.

Thus, many consumers select the commodities while taking into account the delivery times of the commodities. However, the electronic business transaction assisting systems indicated above require the consumers to perform extremely cumbersome procedures for inquiring about delivery times of individual commodities.

### SUMMARY OF THE INVENTION

It is therefore an object of the present invention to provide an electronic business transaction assisting system, a server constituting a portion of the system, method, a program and a recording medium which enable consumers to easily learn delivery times of commodities.

According to a first aspect of this invention, an electronic business transaction assisting system comprises: a memory that stores data indicative of an actual delivery time of each of a plurality of commodities; a desired-delivery inputting portion that inputs data indicative of a desired delivery time; and a controller that selects at least one of the commodities which meets the desired delivery time on the basis of the actual delivery times of the commodities stored in the memory and the desired delivery time input by the desired-delivery inputting portion if the at least one of the plurality of commodities meets the desired delivery time, and provides a result of selection made by the commodity selecting portion.

In the electronic business transaction assisting system as described above, the delivery data of the plurality of commodities are stored in the memory, and the data indicative of the desired delivery time transmitted from the consumer is input to select at least one of the commodities available through the system, which meets the desired delivery time. Then, the consumer is informed of the selected commodity or commodities. Thus, the consumer can readily learn about commodities that meet the desired delivery time without having to make separate inquiries of individual commodities.

According to a second aspect of this invention, a server comprises: a memory for storing data indicative of an actual delivery time of each of a plurality of commodities, and a controller that receives data indicative of a desired delivery time and selects at least one of the plurality of commodities that meets the desired delivery time on the basis of the actual delivery times of the plurality of the commodities stored in the memory and the received desired delivery time if the at least one of the plurality of commodities meets the desired delivery time, and provides a result of the at least one selection made.

According to a third aspect of this invention, a server comprises: a memory for storing commodity data including actual delivery times of commodities, a controller that receives from a user terminal inquiry data including a desired delivery time of each of at least one commodity and selects a portion of a commodity stored in the memory based on the inquiry data received from the user terminal that includes the desired delivery time if the portion of the commodity meets the desired delivery time, and a transmitter that transmits to the user terminal the portion of the commodity data which has been selected.

According to a fourth aspect of this invention, an electronic business transaction assisting method comprises receiving a desired delivery time of a commodity, selecting at least one of the plurality of commodities that meets the desired delivery time on the basis of the actual delivery times of the plurality of commodities stored in a memory and the input desired delivery time if the at least one of the plurality of commodities meets the desired delivery time, and providing a result of the selection made.

According to a fourth aspect of this invention, a computer program for a electronic business transaction assisting system executes an instruction that allows the computer program to receive data indicative of a desired delivery time, select at least one of the plurality of commodities on the basis of the actual delivery times of the plurality of the commodities stored in the memory and the received desired delivery time if the at least one of the plurality of commodities meets the desired delivery time, and provides a result of the at least one selection made.

According to a fourth aspect of this invention, a recording medium for a electronic business transaction assisting system records an instruction to allow a controller to receive data indicative of a desired delivery time, select at least one of the plurality of commodities on the basis of the actual delivery times of the plurality of the commodities stored in the memory and the received desired delivery time if the at least one of the plurality of commodities meets the desired delivery time, and provides a result of the at least one selection made.

### BRIEF DESCRIPTION OF THE DRAWINGS

FIG. 1 is a schematic view of an electronic business transaction assisting system according to one embodiment of the present invention;

FIG. 2 is a schematic view showing an arrangement of a delivery data base;

FIG. 3 is a view illustrating a first example of a display view provided on a select-result output portion;

FIG. 4 is a view illustrating a second example of a display view provided on the select-result output portion;

FIG. 5 is a flow chart illustrating an operation according to one embodiment of an electronic business transaction assisting system of this invention;

FIG. 6 is a view illustrating a third example of a display view provided on the select-result output portion; and

FIG. 7 is view illustrating a fourth example of a display view provided on the select-result output portion.

### DETAILED DESCRIPTION OF PREFERRED EMBODIMENTS

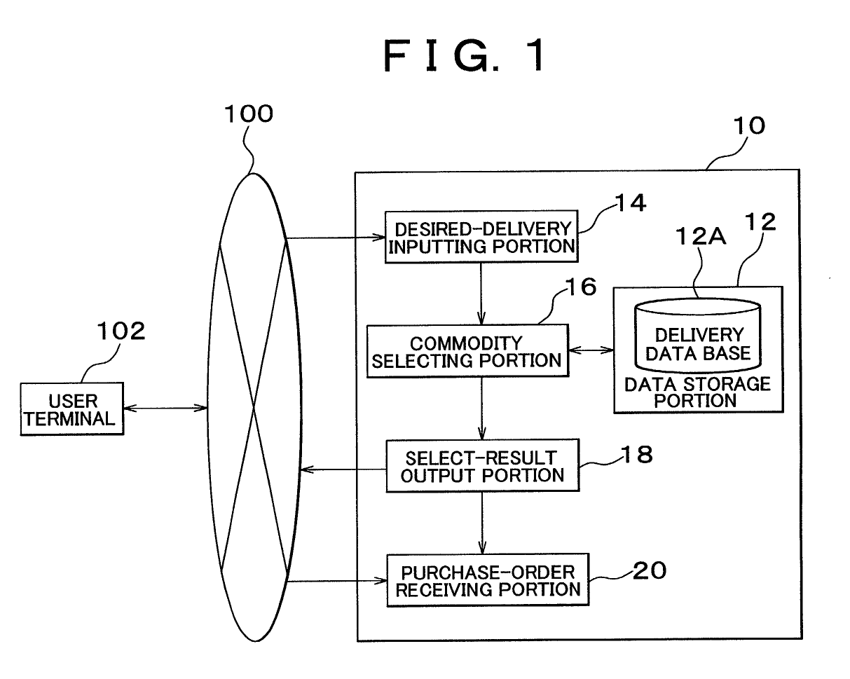

Referring to the accompanying drawings, there will be described an electronic business transaction assisting system and a server constituting a portion of the system according to one embodiment of this invention. An arrangement of the electronic business transaction assisting system and the server constituting a portion of the system of this embodiment will be described first by reference to the schematic view of FIG. 1, in which reference numeral 10 denotes the present electronic business transaction assisting system and the server constituting a portion of the system. The electronic business transaction assisting system and the server 10 is a system that can be arranged to assist users in electronic business transaction of customized parts, i.e., commodities, of automotive vehicles. As shown in FIG. 1, the system 10 is connected through the Internet 100 to user terminals like user terminal 102.

As shown in FIG. 1, the electronic business transaction assisting system and the server 10 consists of a data storage portion 12, a desired-delivery inputting portion 14, a commodity selecting portion 16, a select-result output portion 18 and a purchase-order receiving portion 20. Each of these portions 12-20 will be described in detail.

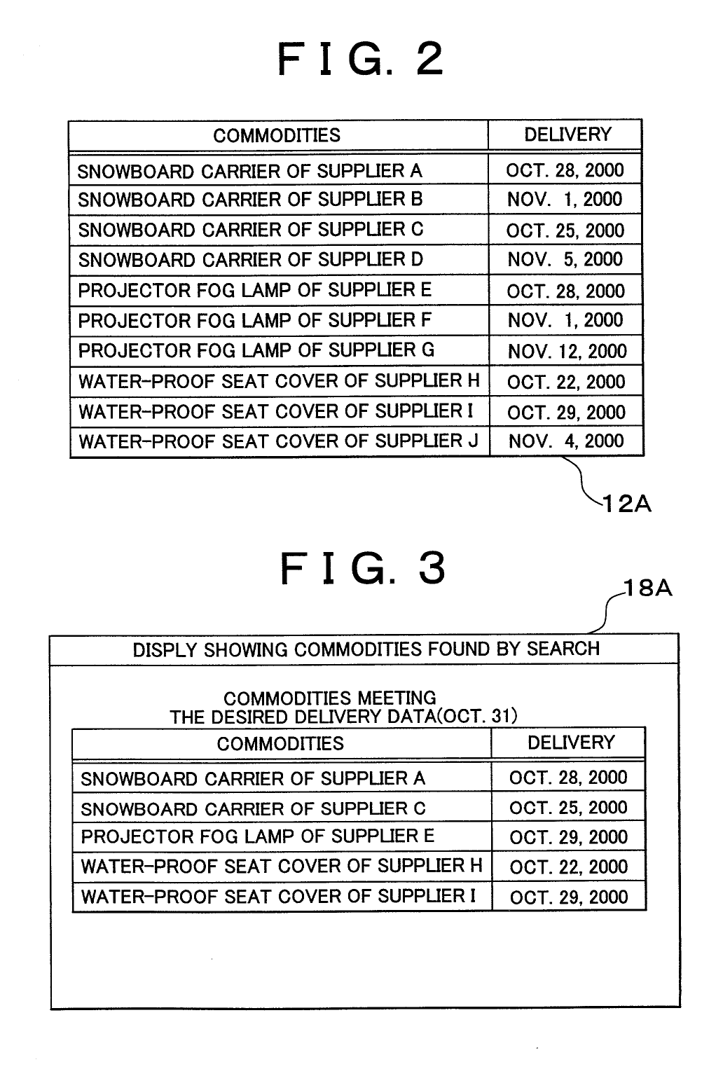

The data storage portion 12 stores a delivery data base 12A. FIG. 2 shows an example of an arrangement of the delivery data base 12A. The delivery data base 12A includes the names of a plurality of kinds of commodities or articles of trade available through the present electronic business transaction assisting system and the server 10, and the delivery dates of the individual commodities, as shown in FIG. 2.

Referring back to FIG. 1, the desired-delivery inputting portion 14 is arranged to receive from the user terminal 102 delivery data indicative of a desired delivery time of commodities. The delivery data, i.e., a key term, indicative of the desired delivery time of commodities are transmitted from the user terminal 102 to the desired-delivery inputting portion 14 of the server 10, through the Internet 100. The delivery time may be specified, for example, by a date, e.g., “Oct. 31, 2000”, or a period of time from the date of the inquiry, e.g., “within one week from the inquiry date”.

The commodity selecting portion 16 is arranged to make a search through the delivery data base 12A, for finding the commodities which meet the desired delivery time. The search is made on the basis of the delivery dates of the commodities stored in the delivery data base 12A of the data storage portion 12, and the desired delivery date which have been input into the server 10 through the desired-delivery inputting portion 14. On the basis of the desired delivery date of the commodities input into the server 10 through the desired-delivery inputting portion 14, the commodity selecting portion 16 finds the commodities the delivery time of which is on or before the desired date.

For example, where the desired-delivery inputting portion 14 inputs “Oct. 31, 2000” into the server 10, while the delivery data base 12A stores delivery data of the commodities as shown in FIG. 2, the commodity selecting portion 16 selects the following commodities: snowboard carrier available from Supplier A as of Oct. 28, 2000; snowboard carrier available from Supplier C as of Oct. 25, 2000; projector fog lamp available from Supplier E as of Oct. 28, 2000; waterproof seat cover available from Suppler H as of Oct. 22, 2000; and water-proof seat cover available from Supplier I as of Oct. 29, 2000.

The select-result output portion 18 is arranged to output a result of the select made by the commodity selecting portion 16. The select-result output portion 18 provides a display indicating the actual delivery dates and the names of the commodities selected by the commodity selecting portion 16, and other information relating to the selected commodities to a display of the user terminal 102. The display is provided the user terminal 102. An example of a display view provided by the select-result output portion 18 is shown at 18A in FIG. 3. The select-result output portion 18 transmits data representative of the display view 18A to the user terminal 102 through the Internet 100, so that the display view 118A is provided on a display of the user terminal 102. The display view 18A includes the desired delivery date input into the server 10 through the desired-delivery inputting portion 14 from the user terminal 102, the names of the commodities selected or found by the commodity selecting portion 16, and the actual delivery dates of the selected commodities.

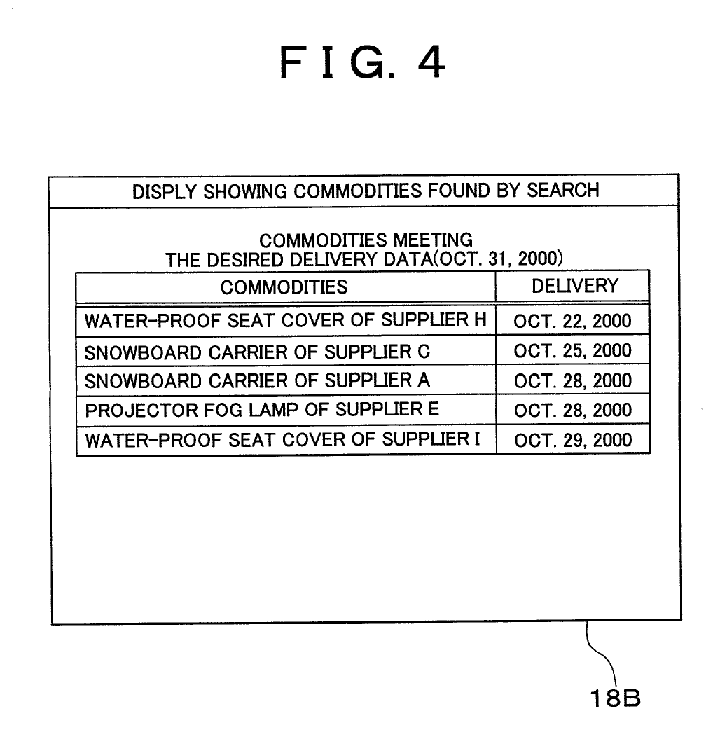

The display view 18A may further include descriptions of the selected commodities. It is noted that the display view 18A may not include the names and actual delivery dates of the commodities which have not been selected by the commodity selecting portion 16. For instance, the display view 18A may be a web page of the Internet. The select-result output portion 18 may be arranged to provide a display view 18B in which the names and actual delivery dates of the commodities selected by the commodity selecting portion 16 are indicated in the order of the delivery dates, as shown in FIG. 4.

Referring back again to FIG. 1, the purchase-order receiving portion 20 is arranged to receive from the user terminal 102 a purchase order of at least one of the commodities selected by the commodity selecting portion 16. The user observing the display view which is provided on the display at the user terminal 102 according to the data received from the select-result output portion 18 is informed of those of the commodities available through the electronic business transaction assisting system and the server 10, which have been selected by the commodity selecting portion 16, i.e., the commodities which meet the delivery time desired by the user. Thus, the user is assisted by the present electronic business transaction assisting system, in deciding the contents of a purchase order to be entered through the user terminal 102, to purchase at least one of the commodities which meet the desired delivery time. The purchase order transmitted from the user terminal 102 is received by the purchase-order receiving portion 20 through the Internet 100.

The purchase-order receiving portion 20 can be arranged to receive other information such as information indicative of whether the user wants the ordered commodities to be delivered on their respective delivery dates, or at one time on the latest one of the actual delivery dates of the ordered commodities. Further, the purchase-order receiving portion 20 may be arranged to permit the user to transmit a purchase order of the commodities not selected by the commodity selecting portion 16. This arrangement is convenient to the user who likes to purchase the commodities the actual delivery dates of which are a few days later than the delivery date desired by the user.

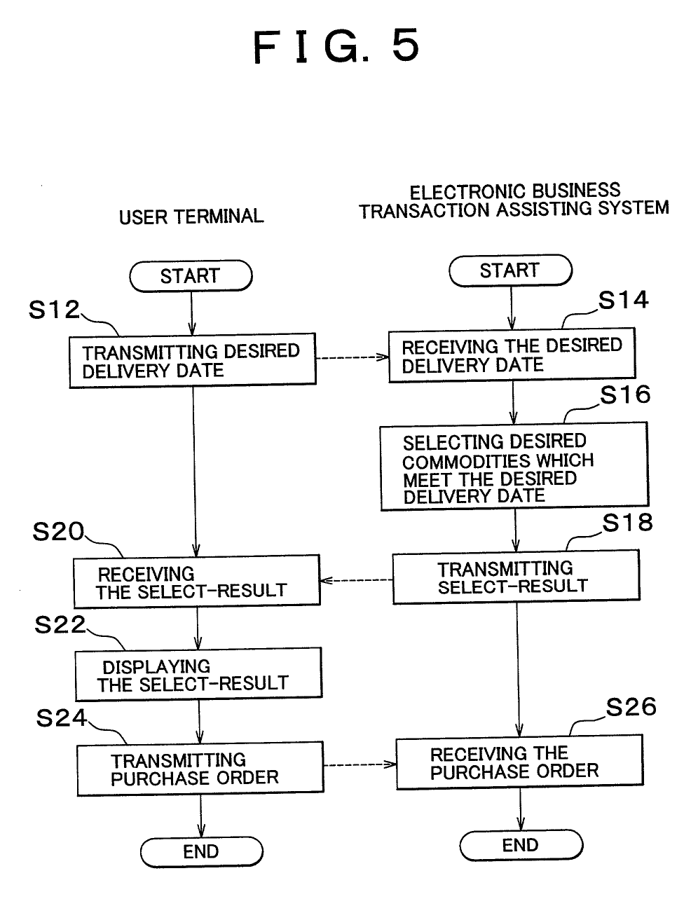

There will next be described an operation of the electronic business transaction assisting system and the server 10 of the present embodiment, together with an electronic business transaction assisting method practiced by the system 10, by reference to the flow chart of FIG. 5 illustrating the operation of the present system 10.

The user of the user terminal 102, who is a consumer, specifies the desired delivery date of commodities, through the user terminal 102, so that the delivery data indicative of the desired delivery date is transmitted to the server 10 (step S12).

The data thus transmitted from the user terminal 102 is received by the desired-delivery inputting portion 14 of the assisting system (S14).

Upon reception of the delivery data indicative of the desired delivery date, the desired-delivery inputting portion 14 provides the server 10 with those delivery dates, and commands the commodity selecting portion 16 to make a search through the delivery date base 12A. Based on the actual delivery dates of the commodities stored in the delivery data base 12A, and based on the desired delivery date of commodities input into the server 10 through the desired-delivery inputting portion 14, the commodity selecting portion 16 selects those of the commodities which meet the desired delivery date (S16). More specifically, on the basis of the desired delivery date, i.e., a key term, that has been input into the server 10 through the desired-delivery inputting portion 14, the commodity selecting portion 16 finds the commodities the delivery time of which is on or before the desired date.

After the commodities meeting the desired delivery date have been selected by the commodity selecting portion 16, the select-result output portion 18 transmits to the user terminal 102 the result of the select made by the commodity selecting portion 16 (S18). As shown FIG. 3, the select-result output portion 18 transmits to the user terminal 102 data indicative of the display view 18A, which may be a web page of the Internet, which includes the delivery date desired by the user and/or the names and actual delivery dates of the selected commodities, so that the display view 18A is provided on the display at the user terminal 102.

The data indicative of the display view 18A transmitted from the select-result output portion 18 are received by the user terminal 102 (S20).

Upon reception of the data indicative of the display view 18A, the user terminal 102 provides the display view 18A on its display (S22). The user of the user terminal 102 observing the display view 18A is informed of those of the commodities available through the electronic business transaction assisting system and the server 10, which have been selected by the commodity selecting portion 16, i.e., the commodities which meet the delivery time desired by the user.

The user observing the display view 18A specifies the contents of a purchase order through the user terminal 102, so that the purchase order is transmitted to the server 10 (S24).

The purchase order transmitted from the user terminal 102 is received by the purchase-order receiving portion 20 of the server 10 (S26), so that the purchase order is accepted by the assisting system 10.

Features and advantages of the present electronic business transaction assisting system and the server 10 will be described. In the present assisting system 10, the delivery data base 12A of the data storage portion 12 stores data indicative of the actual delivery dates of a plurality of commodities, and the desired delivery date of the commodities is input through the desired-delivery inputting portion 14 into the server 10. The commodity selecting portion 16 selects at least one of the commodities which meets the desired delivery date, and the select-result output portion 18 transmits data indicative of the result of the select made by the commodity selecting portion 16. Thus, the consumer can readily learn about the commodities that meet the desired delivery date, without having to make separate inquiries of individual commodities.

The present server 10 is further arranged such that the select-result output portion 18 permits the user terminal 102 to provide the display view indicating the names and actual delivery dates of the commodities which have been found by the commodity selecting portion 16. This arrangement enables the consumer or the user of the user terminal 102 to easily learn about the commodities meeting the desired delivery time.

The present server 10 is further arranged such that the purchase-order receiving portion 20 receives the purchase order specifying at least one of the commodities selected by the commodity selecting portion 16. This arrangement enables the consumer to easily place the purchase order of the desired commodities that meet the desired delivery time.

In the present server 10, the purchase-order receiving portion 20 is arranged to receive information indicative of whether the user wants the ordered commodities to be delivered on their respective delivery dates, or at one time on the latest one of the actual delivery dates of the ordered commodities. This arrangement is also convenient to the consumer.

In the server 10 according to the present embodiment of the invention, the select-result output portion 18 is arranged to provide the display view indicative of the names and actual delivery dates of only the commodities selected by the commodity selecting portion 16, but may not indicative of the names and actual delivery dates of the commodities not selected by the commodity selecting portion 16. However, the select-result output portion 18 may be arranged to provide a display view indicative of the names and other information of not only the commodities selected by the commodity selecting portion 16, and but also the commodities not selected by the commodity selecting portion 16, such that a set of information of the selected commodities and a set of information of the non-selected commodities are distinguishable from each other.

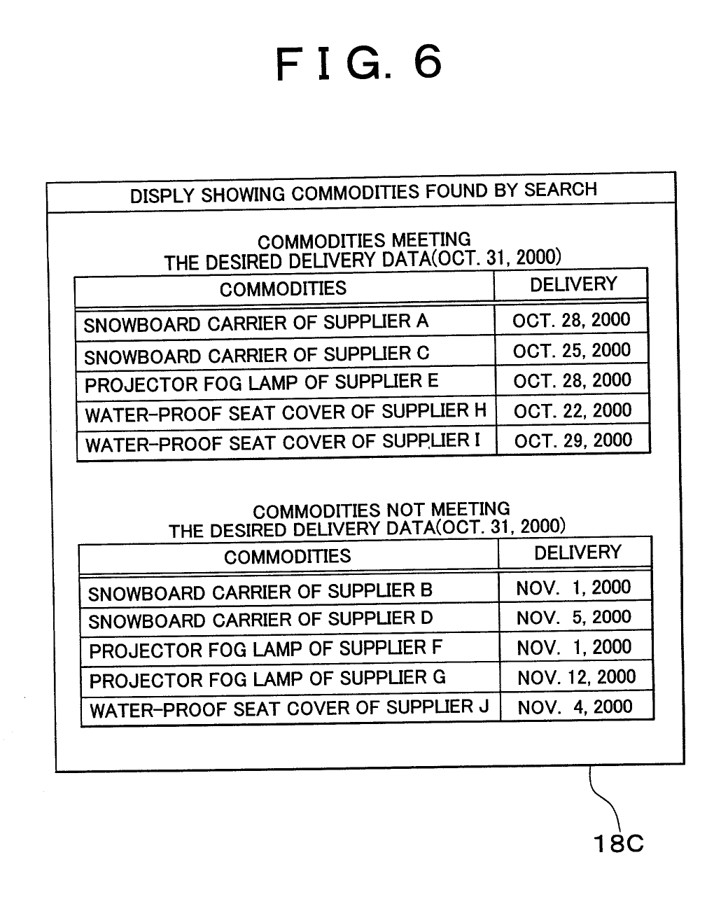

For instance, the select-result output portion 18 may be arranged to provide a display view 18C including two separate sections assigned to respectively indicate the names and actual delivery dates of the commodities selected by the commodity selecting portion 16, and the names and actual delivery dates of the commodities not selected by the commodity selecting portion 16, as shown in FIG. 6.

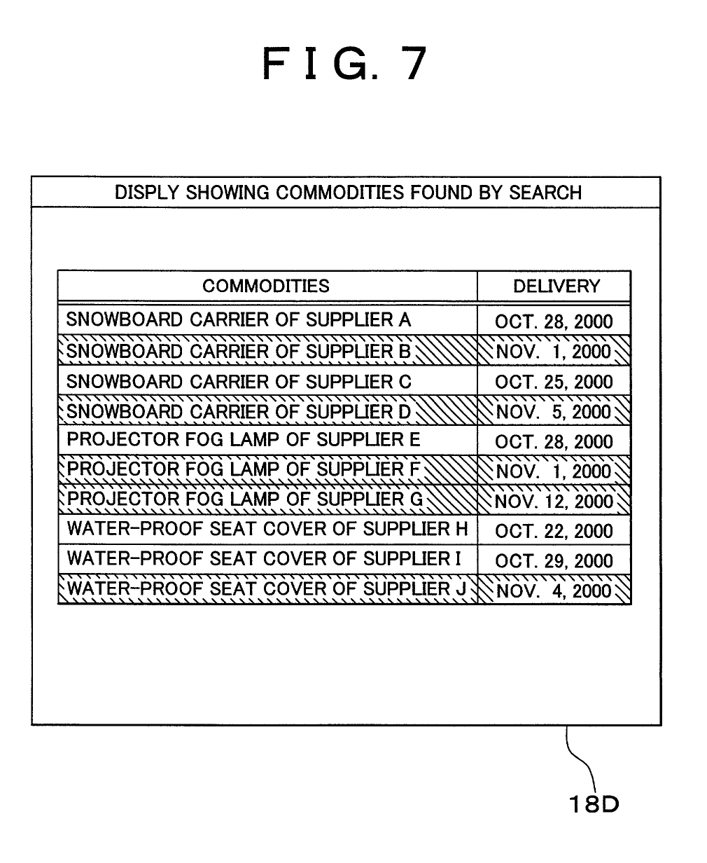

Alternatively, the select-result output portion 18 may be arranged to provide a display view 18D in which the names and actual delivery dates of the commodities selected by the commodity selecting portion 16, and the names and actual delivery dates of the commodities not selected by the commodity selecting portion 16, are indicated in respective different formats. For example, in the respective different design, i.e., for example fonts, or colors, as shown in FIG. 7, can be displayed.

The above-indicated modified arrangements that permit distinction between the names and other information of the commodities selected by the commodity selecting portion 16 and those of the non-selected commodities also enable the consumer or the user of the user terminal 102 to easily learn which commodities meet the desired delivery time. The user of the user terminal 102 observing the select result displayed according to the data received from the select-result output portion 18 arranged as described above can know all of the desired commodities that are available through the electronic business transaction assisting system and the server 10, and the commodities which have been selected by the commodity selecting portion 16, i.e., those of the commodities which meet the desired delivery date.

While the electronic business transaction assisting system and the server 10 constructed according to the present embodiment of this invention can be adapted to assist the user in making an inquiry of customized parts of automotive vehicles, the principle of the present invention is equally applicable to electronic business transaction assisting systems adapted to assist the user in making an inquiry of any other types of commodities or articles of trade. The electronic business transaction assisting system according to the present invention is particularly advantageous when applied to flowers, imported goods and other commodities the delivery time of which is an important factor to the consumer in deciding whether the consumer should purchase the commodities. Examples of the commodities to which the electronic business transaction assisting system of this invention is advantageously applicable include birthday presents and wedding gifts, and any other commodities that should be delivered before a predetermined time.

While the electronic business transaction assisting system according to the illustrated embodiment is adapted to assist the users in business transaction of customized parts of automobiles, the principle of this invention is equally applicable to an electronic business transaction assisting system adapted to handle other kinds of commodities. For example, where the electronic business transaction assisting system is adapted to handle various kinds of commodities, the system may be arranged to receive from the user terminals inquiry data including commodity-kind data indicative of at least one desired kind of commodity, as well as desired-delivery data indicative of a desired delivery time of each kind of commodity indicated by the commodity-kind data. In this case, an inquiry-data inputting portion provided in place of the desired-delivery inputting portion 14 may receive the commodity-kind data before the desired-delivery data or vice versa, or at the time from the user terminal.

If a search as above described is executed on a kiosk terminal that is a multi-media information terminal and is located in a shop, the kiosk terminal may have a data storage portion, a desired-delivery inputting portion, a commodity selecting portion, a select-result output portion and a purchase-order receiving portion as above described. In this case, actual deliver times may be transmitted through the Internet. The data storage portion may store the transmitted actual deliver times.

There may be a plurality of user terminals. There may be a plurality of delivery dates received by desired-delivery inputting portion 14 form from the user terminal 102.

Further, the desired delivery time may be time, i.e., 12 o'clock. In this case, for example, it may be a delivery service of foods, i.e., pizza and sushi etc.

A recording medium of the invention may be CD-ROM(s).

In the illustrated embodiments, the controller is implemented with a general purpose processor. It will be appreciated by those skilled in the art that the controller can be implemented using a single special purpose integrated circuit (e.g., ASIC) having a main or central processor section for overall, system-level control, and separate sections dedicated to performing various different specific computations, functions and other processes under control of the central processor section. The controller can be a plurality of separate dedicated or programmable integrated or other electronic circuits or devices (e.g., hardwired electronic or logic circuits such as discrete element circuits, or programmable logic devices such as PLDs, PLAs, PALs or the like). The controller can be suitably programmed for use with a general purpose computer, e.g., a microprocessor, microcontroller or other processor device (CPU or MPU), either alone or in conjunction with one or more peripheral (e.g., integrated circuit) data and signal processing devices. In general, any device or assembly of devices on which a finite state machine capable of implementing the procedures described herein can be used as the controller. A distributed processing architecture can be used for maximum data/signal processing capability and speed.

While the invention has been described with reference to what are preferred embodiments thereof, it is to be understood that the invention is not limited to the preferred embodiments or constructions. To the contrary, the invention is intended to cover various modifications and equivalent arrangements. In addition, while the various elements of the preferred embodiments are shown in various combinations and configurations, which are exemplary, other combinations and configurations, including more, less or only a single element, are also within the spirit and scope of the invention.

What is claimed is:

1. An electronic business transaction assisting method which uses a memory that stores actual delivery times of a plurality of commodities comprising:
receiving a desired delivery time;
selecting at least one of the plurality of commodities on the basis of the actual delivery times of the plurality of commodities stored in the memory and the input desired delivery time if the at least one of the plurality of commodities meets the desired delivery time; and
providing a result of the selection made.

2. The electronic business transaction assisting method according to claim 1, further comprising providing data for displaying information relating to the at least one of the commodities which is selected.

3. The electronic business transaction assisting method according to claim 1, further comprising providing data for displaying a first set of information relating to the at least one of the commodities which has been selected, and a second set of information relating to at least one of the commodities which has not been selected, such that the first and second sets of information are distinguishable from each other.

4. The electronic business transaction assisting method according to claim 1, further comprising receiving from a user terminal a purchase order for purchasing at least one of the commodities which has been selected.

5. The electronic business transaction assisting method according to claim 4, wherein when the purchase order is for purchasing a plurality of commodities, and further comprising receiving from the user terminal information indicative of whether the plurality of commodities to be purchased should be delivered at respective delivery times or at one delivery time.

6. A server comprising:
a memory that stores data indicative of an actual delivery time of each of a plurality of commodities; and
a controller that receives data indicative of a desired delivery time, selects at least one of the plurality of commodities on the basis of the actual delivery times of the plurality of the commodities stored in the memory and the desired delivery time if the at least one of the plurality of commodities meets the desired delivery time, and provides a result of the at least one selection made.

7. The server according to claim 6, wherein the controller provides data for displaying information relating to the at least one of the selected commodities.

8. The server according to claim 6, wherein the controller provides data for displaying a first set of information relating to the at least one of the commodities, and a second set of information relating to at least one of the commodities which has not been selected, such that the first and second sets of information are distinguishable from each other.

9. The server according to claim 6, wherein the controller further receives from a user terminal a purchase order for purchasing at least one of the commodities which has been selected.

10. The server according to claim 9, wherein when the purchase order is for purchasing a plurality of commodities, the controller receives from the user terminal information indicative of whether the plurality of commodities to be purchased should be delivered at respective delivery times or at one delivery time.

11. A server that communicates with a user terminal through a communication network, for assisting a user of the user terminal in making a decision regarding a purchase of commodities, the server comprising:
a memory that stores data indicative of an actual delivery time of each of a plurality of commodities of different kinds; and
a controller that receives inquiry data indicative of a desired delivery time, searches through the memory based on the actual delivery time of each commodity stored in the memory and the desired delivery time for selecting at least one of the plurality of commodities if the at least one of the plurality of commodities meets the desired delivery time, and provides a result of the search.

12. A server comprising:
a memory that stores commodity data including actual delivery times of commodities;
a controller that receives from a user terminal inquiry data including a desired delivery time of each of at least one commodity and selects a portion of a commodity stored in the memory based on the inquiry data received from the user terminal that includes the desired delivery time if the portion of the commodity meets the desired delivery time; and
a transmitter that transmits to the user terminal the portion of the commodity data which has been selected.

13. The server according to claim 12, wherein the portion of the commodity data transmitted by the transmitter includes a name of a commodity which meets the desired delivery time of each of the at least one commodity and the actual delivery times of commodities stored in the memory.

14. The server according to claim 12, wherein the controller further receives from the user a purchase order for purchasing at least one of the commodities included in the portion of the commodity data, which is selected at the user terminal.

15. The server according to claim 12, wherein the controller further processes the commodity data such that the portion of the commodity data which has been selected and a remaining portion of the commodity data which has not been selected are distinguishable from each other, and
wherein the transmitter transmits to the user terminal the commodity data that was processed.

16. An electronic business transaction assisting system comprising:
a memory that stores data indicative of an actual delivery time of each of a plurality of commodities;
a desired-delivery inputting portion that inputs data indicative of a desired delivery time; and
a controller that selects at least one of the commodities which meets the desired delivery time on the basis of the actual delivery times of the commodities stored in the memory and the desired delivery time input by the desired-delivery inputting portion if the at least one of the plurality of commodities meets the desired delivery time, and provides a result of selection made by the commodity selecting portion.

17. A computer program for a electronic business transaction assisting system comprising:
a first instruction that stores in a memory data indicative of an actual delivery time of each of a plurality of commodities; and
a second instruction that allows the computer program to receive data indicative of a desired delivery time, select at least one of the plurality of commodities on the basis of the actual delivery times of the plurality of the commodities stored in the memory and the received desired delivery time if the at least one of the plurality of commodities meets the desired delivery time, and provides a result of the at least one selection made.

18. A recording medium for a electronic business transaction assisting system, the recording medium including computer-readable instructions comprising:
a first instruction to store in a memory data indicative of an actual delivery time of each of a plurality of commodities; and
a second instruction to allow a controller to receive data indicative of a desired delivery time, select at least one of the plurality of commodities on the basis of the actual delivery times of the plurality of the commodities stored in the memory and the received desired delivery time if the at least one of the plurality of commodities meets the desired delivery time, and provides a result of the at least one selection made.

19. A computer program for a electronic business transaction assisting system which uses a memory that stores actual delivery times of a plurality of commodities comprising:
a first instruction that allows the computer program to receive data indicative of a desired delivery time, select at least one of the plurality of commodities on the basis of the actual delivery times of the plurality of the commodities stored in the memory and the received desired delivery time if the at least one of the plurality of commodities meets the desired delivery time and;
a second instruction that allows the computer program to provide a result of the at least one selection made.

20. A recording medium for a electronic business transaction assisting system which uses a memory that stores actual delivery times of a plurality of commodities comprising:
a first instruction to allow a controller to receive data indicative of a desired delivery time, select at least one of the plurality of commodities on the basis of the actual delivery times of the plurality of the commodities stored in the memory and the received desired delivery time if the at least one of the plurality of commodities meets the desired delivery time and;
a second instruction to allow the controller to provide a result of the at least one selection made.
